(19) United States
(12) Patent Application Publication
(10) Pub. No.: US 2022/0324332 A1
(43) Pub. Date: Oct. 13, 2022

(54) System and Method for Supervised Autonomous Traffic Management

(71) Applicant: Hyperloop Technologies, Inc., Los Angeles, CA (US)

(72) Inventors: Jerome Hubert Wei, Los Angeles, CA (US); Walter Wang, Hacienda Heights, CA (US); Leo Waiho Wong, Walnut, CA (US)

(73) Assignee: Hyperloop Technologies, Inc., Los Angeles, CA (US)

(21) Appl. No.: 17/679,121

(22) Filed: Feb. 24, 2022

Related U.S. Application Data
(60) Provisional application No. 63/177,789, filed on Apr. 21, 2021.
(60) Provisional application No. 63/172,547, filed on Apr. 8, 2021.

(51) Int. Cl. B60L 13/06; B60L 13/10

(52) U.S. Cl. CPC B60L 13/06; B60L 13/10

(57) ABSTRACT

A solution is disclosed that is related to the supervised operation of an autonomous hyperloop network. The disclosed solution provides for a hybrid approach to managing an autonomous network wherein human-based and computer-based commands may be send to a plurality of hyperloop pods in order to provide safety and efficiency for the hyperloop network. Issues may be presented to human operators such that actions may be taken to address the issues. Additionally, recommendations as to which action to take may be presented to the human operator via a user interface. The human operator may define a set of global restrictions and operational parameters as a policy that constrains the operations of the hyperloop pods within the hyperloop network.

### CROSS REFERENCE AND PRIORITY TO RELATED APPLICATIONS

This application claims the benefit of priority to: (1) U.S. Provisional No. 63/172,547 entitled “SYSTEM AND METHOD FOR SUPERVISORY TRAFFIC MANAGEMENT,” filed on Apr. 8, 2021 and (2) U.S. Provisional No. 63/177,789 entitled “SYSTEM AND METHOD FOR AUTONOMOUS HYPERLOOP TRAFFIC MANAGEMENT,” filed on Apr. 21, 2021.

All the aforementioned applications are hereby incorporated by reference in their entirety.

### BACKGROUND

Hyperloop is a passenger and cargo transportation system relying on a sealed tube and a bogie attached to a pod. The sealed tube has a substantially lower air pressure than the external environment. As such, the bogie and the attached pod may travel with reduced air resistance, thus increasing energy efficiency as well as performance. Further, the acceleration and the velocity of the bogie may be substantially higher than a comparable bogie operating within a gas environment having a higher pressure (including at standard air pressure of one atmosphere). Some hyperloop systems rely on magnetic levitation (sometimes referred to as “maglev”). The advantage of using maglev is a further reduction in friction viz. the resistance between a traditional wheel and a traditional track is eliminated by using a maglev-based bogie. Hyperloop is in the early stages of development and commercialization. However, the projected velocity of the bogie may exceed 700 mph (1,127 km/h) in commercialized implementations.

Transportation has largely been dominated by human-initiated operations. For example, humans manually operate traditional locomotive engines on existing rail systems. The same is true for automobiles and aircraft. Human operators are prone to error, often leading to catastrophic results which include loss of life. Autonomous operation of transportation is a growing area of interest because sophisticated autonomous operation solutions may mitigate the human error that exists today.

However, a fully autonomous solution may impede the desired operation of a transportation network. For instance, an operator may desire to prioritize cargo shipments as part of a branding strategy that has more to do with marketing and less to do with efficient transportation. A fully autonomous solution may not enable such use cases. What is needed is a system and method for supervisory management of an autonomous hyperloop network.

### SUMMARY

A solution for supervised management of an autonomous hyperloop network is disclosed, wherein the solution is comprised of a method, a system, a computing device, a computer-readable medium or a combination thereof. The solution may detect a first input, at a user interface, to select a first play within a plurality of plays, the first play containing a first operation, wherein the first operation causes a first hyperloop pod to invoke a first autonomous operation. The solution may further execute the first play and detect a second input, at the user interface, to select a second play within the plurality of plays, wherein the second play contains a second operation that causes a second hyperloop pod to invoke a second autonomous operation. The solution may further execute the second play and monitor a wayside support system.

The solution may further detect a third input, at the user interface, to define a set of operational parameters. The solution may further detect a fourth input, at the user interface, to define a set of global restrictions and detect a fifth input, at the user interface, to define a policy, wherein the policy relates to the set of operational parameters, the set of global restrictions, or a combination thereof. The policy may further limit the first operation, the second operation, or a combination thereof, wherein the policy is stored in a memory. The solution may further detect a sixth input, at the user interface, to select the policy from the memory and execute the policy, wherein the executing causes the first play and the second play to conform to the policy.

The solution may further detect an issue reported by the wayside support system and send, via the wayside support system, a third autonomous operation to the first hyperloop pod. The solution may further define the issue as traffic-related, maintenance-related, safety-related, or a combination thereof. The solution may further generate an assessment report containing a first action, wherein the first action is configured to address an issue in the hyperloop network. The assessment report may be stored in the memory. The solution may further present, at the user interface, the assessment report and present, at the user interface, the first action.

The solution may further generate a recommendation to execute the first action, wherein the recommendation is derived from the issue. The solution may further present, at the user interface, the recommendation and detect an eighth input, at the user interface, to execute the recommendation. The solution may further execute, at the processor, the recommendation.

The solution may further detect a conflict at a junction within the hyperloop network, wherein the conflict occurs if the second hyperloop pod is scheduled to traverse the junction at substantially the same time as the first hyperloop pod. The solution may further command, via the wayside support system, the first hyperloop pod to traverse the junction before the second hyperloop pod is scheduled to traverse the junction.

The solution may further determine that the junction is a branch within a hyperloop portal. The solution may further adjust the number of hyperloop pods operating within the hyperloop network and direct, via the wayside support system, the first hyperloop pod into a convoy comprised of one or more hyperloop pods, wherein the second hyperloop pod is among the one or more hyperloop pods.

The solution may further detect an emergency within a first hyperloop route, wherein the first hyperloop route is part of the hyperloop network. The solution may further direct, via the wayside support system, the first hyperloop pod to an emergency access point and direct, via the wayside support system, the second hyperloop pod to avoid the emergency via a second hyperloop route, wherein the second hyperloop route is part of the hyperloop network.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1A is a block diagram illustrating a transportation network.

FIG. 1B is a block diagram illustrating a transportation network.

FIG. 1C is a block diagram illustrating a transportation network.

FIG. 1D is a block diagram illustrating a transportation network.

FIG. 2A is a block diagram of a supervisory traffic management system, a wayside support system, and a hyperloop pod system.

FIG. 2B is a block diagram of a supervisory traffic management system.

FIG. 3A is a flowchart of a process for executing a play from a playbook associated with a hyperloop network.

FIG. 3B is a flowchart of a process for executing a policy associated with a hyperloop network.

FIG. 3C is a flowchart of a process for executing a set of coordinated operations in response to monitoring wayside elements.

FIG. 3D is a flowchart of a process for directing the movement of hyperloop pods.

FIG. 3E is a flowchart of a process for generating and selecting a recommended set of operations.

FIG. 4A is a block diagram of an autonomous traffic management system, a supervisory traffic management system, a wayside support system, a hyperloop pod system, a transit operation system, a portal operation system, a depot operation system, and an emergency access point operation system.

FIG. 4B is a block diagram of a transit operation system.

FIG. 4C is a block diagram of a portal operation system.

FIG. 4D is a block diagram of a depot operation system.

FIG. 4E is a block diagram of an emergency access point operation system.

FIG. 5A is a flowchart illustrating a process for directing a hyperloop pod operating en route in a hyperloop network.

FIG. 5B is a flowchart illustrating a process for directing a hyperloop pod at a portal within a hyperloop network.

FIG. 5C is a flowchart illustrating a process for directing a hyperloop pod to an emergency access point.

FIG. 6 is a block diagram illustrating an example server suitable for use with the various aspects described herein.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Hyperloop is an evolving technology that can address many existing problems, including: long travel times, high energy costs, undesirable emissions output, addressing traffic congestion, updating obsolete infrastructure, avoiding non-optimal fare assignment, etc. Transportation systems are undergoing a shift from human-operated vehicles to autonomously operated vehicles. One motivation for the shift is due to human error causing accidents. Autonomous operation may be less prone to errors that would otherwise be made by a corresponding human operator. Without controversy, safer modes of transportation are more desirable than ones that are unsafe. While autonomous operation may be safer, there exist many challenges to the full realization of autonomous transportation modalities.

An autonomous transportation system may not address all the needs of hyperloop transportation. In general, hyperloop networks are within a more controlled environment compared with other modes of transportation. The hyperloop tube is physically sealed and managed by an operator that is responsible for the safety and maintenance of the hyperloop tube (as well as other elements of the hyperloop network). Not only is the environment more controlled, the hyperloop pods may be designed to operate substantially autonomously. In many situations, the hyperloop pod may be required to be autonomously operated given the high velocities and critical-timing requirements that may simply exceed human capabilities (e.g., reaction time). In contrast, an automobile operates in a highly uncontrolled environment (e.g., freeways). Further, every driver has complete control of the vehicle, thus enabling human error to cause accidents, ones that are often unpredictable.

However, a fully autonomous transportation system may not meet the needs of an operator. For instance, a hyperloop operator may rely on substantially autonomous operation of the pods, but the hyperloop operator may desire macrolevel control of the hyperloop network for a number of reasons. One such reason might be because the autonomous systems simply do not have the capability to address complex problems. For example, a hyperloop operator may desire to prioritize cargo shipments as a new business strategy. Often, decisions may not be completely binary. For example, addressing maintenance issues may be constrained by a lack of resources, thus requiring a human operator to decide which maintenance events require prioritization.

The disclosed solution provides a system and method for supervisory management of an autonomous hyperloop network. The disclosed solution enables human operators to control the non-autonomous and autonomous elements within the hyperloop network, including substantially autonomous hyperloop pods. The disclosed solution further provides a user interface for human operators to visualize the operations invoked within the hyperloop network (e.g., establishing a maintenance policy for hyperloop pods). The disclosed solution addresses the aforementioned problems as well as enables the further growth and progress of the hyperloop mode of transportation.

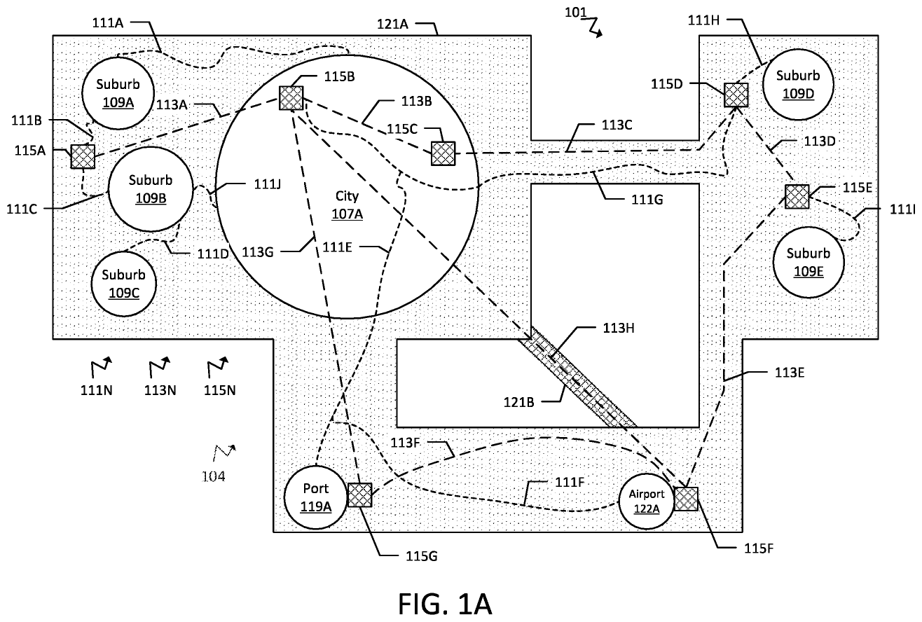

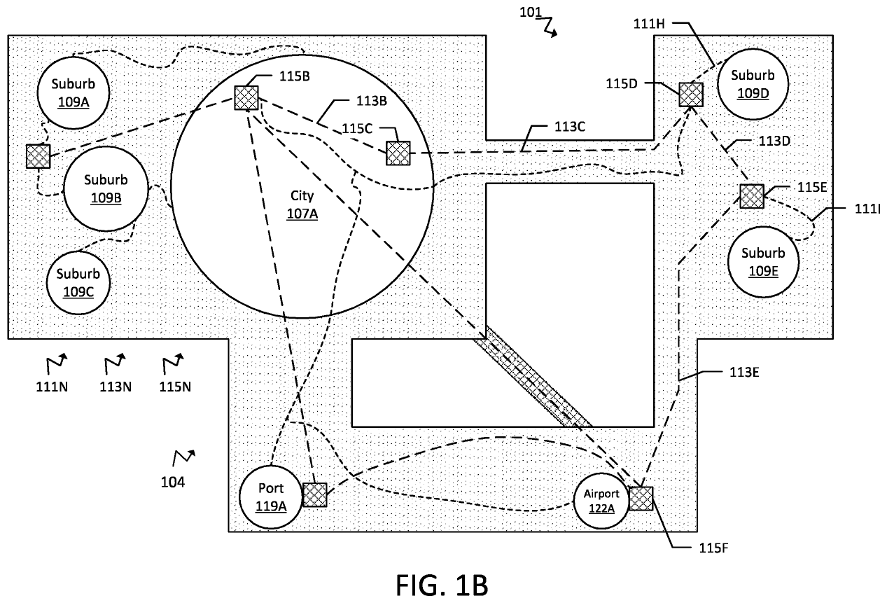

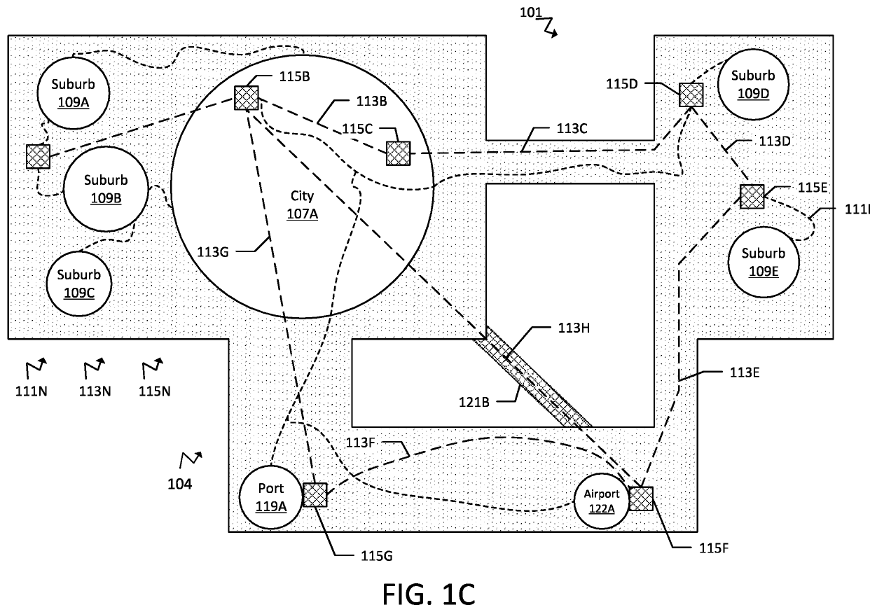

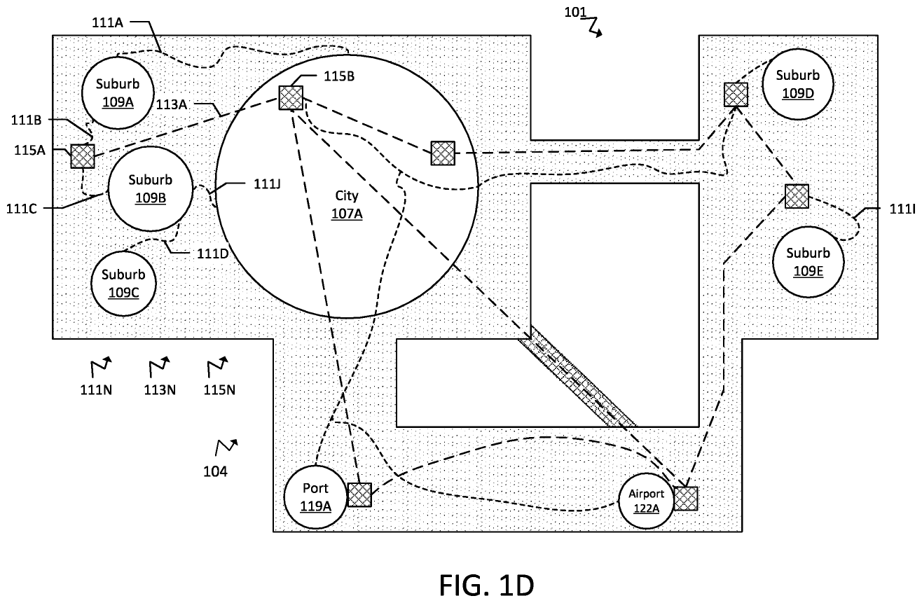

FIG. 1A is a block diagram illustrating a transportation network 101. The transportation network 101 is be deployed within a land area 121A. The land area 121A may be defined by a number of parameters. For instance, the land area 121A may be defined by land that is owned, purchasable, and/or alienable. In some areas of the world, land is unavailable for use as the land may be designated as a nature preserve, in which case no transportation modalities may be deployed therein. In another situation, the land may be unavailable for purchase due to competing economic uses (e.g., an industrial company is using the land for extraction of mineral resources). As such, the land outside the shaded land area 121A may be considered unusable by the transportation network 101.

A city 107A is be disposed on the land area 121A. The city 107A may be considered a large city (e.g., London, Mumbai, etc.). As such, the city 107A is be connected by a myriad of transportation modalities including rail, automobile, ship, etc. Many cities are surrounded by smaller municipalities or suburbs. For illustrative purposes, the cities and suburbs referred to herein should generally be considered relative and not exact. For instance, a suburb in China may be considered a large city in Eastern Europe or Australia. One of skill in the art will appreciate that some metropolitan areas are large and some are small.

The land area 121A has a first suburb 109A, a second suburb 109B, a third suburb 109C, a fourth suburb 109D, and a fifth suburb 109E. The suburbs 109A, 109B, 109C, 109D, 109E may be generally considered metropolitan areas that are smaller in both size and population than a similarly situated city (e.g., the city 107A). In one aspect, the suburbs 109A, 109B, 109C, 109D, 109E may generally be considered single-use areas of land (e.g., a particular suburb may be substantially residential while another suburb may be substantially commercial). On the other hand, the city 107A may be of mixed use where residential, commercial, and industrial use all coexist.

The transportation network 101 has a first portal 115A, a second portal 115B, a third portal 115C, a fourth portal 115D, a fifth portal 115E, a sixth portal 115F, and a seventh portal 115G. The portals 115A, 115B, 115C, 115D, 115E, 115F, 115G may forma plurality of portals 115N. The plurality of portals 115N are locations where a hyperloop pod may perform a number of actions, including but not limited to: load passengers, unload passengers, load cargo, unload cargo, perform maintenance, remove pods from service, add pods to service, change operating personnel, etc. One of skill in the art will appreciate that the plurality of portals 115N may have slightly different functionality but perform many similar functions. For example, a seaport coupled to a portal may have many of the characteristics of a seaport and a train station, plus the unique aspects of hyperloop (e.g., emission-free vehicles, moving platforms, automatic tractors, etc.).

The transportation network 101 has a port 119A. The port 119A is generally configured to dock ships at berths, in one aspect. For example, cargo is predominately transported by sea via container-based cargo ships. When cargo ships dock, the cargo containers are unloaded onto dry land. Traditionally, a semi-truck arrives with a trailer to receive and deliver cargo containers.

The transportation network 101 has an airport 122A. The airport 122A is generally configured to enable air-based modes of transportation (e.g., airplane, helicopter, etc.). In the instant example, the airport 122A serves the city 107A, the port 119A, and the suburbs 109A, 109B, 109C, 109D, 109E.

The portal 115A is connected to the portal 115B via a route 113A. The route 113A is generally configured to provide an environment for the hyperloop pod in which to travel. The route 113A, for instance, may be comprised of an elevated series of pylons that support an above-ground tube, i.e., referred to as “hyperstructure.” Within the tube, a near-vacuum pressure environment provides lowered air resistance thus increasing velocity, energy efficiency, etc. In another aspect, the route 113A may be subterranean and contained within a similar tube as the above-ground example above. While the route 113A, and many other similar illustrations, are denoted with substantially straight lines, one of skill in the art will appreciate that natural curves and turns would be present for a hyperstructure in a commercial deployment.

A route 113B connects the portal 115B to the portal 115C. A route 113C connects the portal 115C to the portal 115D. A route 113D connects the portal 115D to the portal 115E. A route 113E connects the portal 115E to the portal 115F. A route 113F connects the portal 115F to the portal 115G. A route 113G connects the portal 115G to the portal 115B. A route 113H connects the portal 115F, near the airport 122A, to the portal 115B. The route 113H is disposed along a land area 121B. The land area 121B may be considered a congested area of land that has minimal room for additional hyperloop routes disposed along the route 113H. On the one hand, the route 113H provides substantially direct access between the airport 122A and the city 107A. On the other hand, the route 113H may become quickly overwhelmed by traffic demand, due in part to the narrowness of the land area 121B.

The routes 113A, 113B, 113C, 113D, 113E, 113F, 113G forma plurality of routes 113N having substantially similar characteristics. One of skill in the art will appreciate that the plurality of portals 115N and the plurality of routes 113N are used for illustrative purposes and may have multiple instances within a particular location. For instance, the portal 115A may be comprised of three smaller portals (not shown) that form a discrete transportation network. The plurality of routes 113N is comprised of hyperstructure that may be subterranean, underwater, on-ground, above-ground, or a combination thereof.

The plurality of routes 113N and the plurality of portals 115N may form a hyperloop network 104. The hyperloop network 104 may have a plurality of hyperloop pods operating therein. In one aspect, the hyperloop network 104 may have wayside communications systems near the plurality of routes 113N. The hyperloop network 104 may be managed by systems that are autonomous, human-operated, or combination thereof. The hyperloop network 104 may be serviced by a number of maintenance vehicles that may be stored within the plurality of portals 115N or in other facilities designed to house maintenance vehicles and equipment.

A plurality of roads 111N may be comprised of a first road 111A, a second road 111B, a third road 111C, a fourth road 111D, a fifth road 111E, a sixth road 111F, a seventh road 111G, an eighth road 111H, a ninth road 111I, and a tenth road 111J. The plurality of roads 111N may support any existing mode of ground transportation, including, but not limited to, automobile, rail, trolley, subway, bus, or combination thereof. In modernized cities, high-speed rail may be considered a right-of-way user of the plurality of roads 111N. One of skill in the art will appreciate that the plurality of roads 111N is utilized for illustrative purposes and may, in one aspect, simply be the means by which an existing, non-hyperloop vehicle travels.

The road 111A may connect the suburb 109A to the city 107A. The road 111B may connect the portal 115A to the suburb 109A. The road 111C may connect the portal 115A to the suburb 109B. The road 111D may connect the suburb 109B to the suburb 109C. The road 111E may connect the port 119A to the city 107A. The road 111F may connect the airport 122A to the road 111E. The road 111G may connect the city 107A to the portal 115D. The road 111H may connect the portal 115D to the suburb 109D. The road 111I may connect the portal 115E to the suburb 109E. The road 111J may connect the city 107A to the suburb 109B.

In one aspect, the suburbs 109A, 109B, 109C, 109D, 109E are connected to the city 107A. In many metropolitan areas, people reside in suburbs and commute to larger city centers. The cities generally have more commercial and industrial opportunities for workers. Stated differently, the land use in the suburbs 109A, 109B, 109C, 109D, 109E may be quite different than that of the city 107A because the suburbs 109A, 109B, 109C, 109D, 109E are primarily residential, and the city 107A is mixed-use. One reason for the difference is simply the land use density viz. city use is denser than suburban use.

In one aspect, the hyperloop portal 115A is an example of how the suburbs 109A, 109B may utilize hyperloop. For instance, a worker living in the suburb 109A may take the road 111B to the portal 115A where the worker may park the car in a garage. Then, the worker may use the hyperloop route 113A to arrive at the portal 115B within the city 107A. The worker could then walk to a nearby place of work (e.g., an office complex).

In another example, the hyperloop portal 115E is positioned at the right side of the land area 121A. One of skill in the art will appreciate that most of the suburbs 109A, 109B, 109C, 109D, 109E are connected by the plurality of roads 111N. However, the introduction of the hyperloop portal 115E in the right area of the land area 121A provides an opportunity for land use at and around the hyperloop portal 115E.

The plurality of roads 111N and the plurality of routes 113N form a mesh by redundantly connecting many points within the transportation network 101 (e.g., the suburb 109B has several entries and exits). In contrast, the portal 115E is only connected by the hyperloop route 113D. Such a deployment is an example of how a hyperloop portal may encourage growth in an underutilized area of land. A new, efficient mode of transportation like hyperloop may encourage people in the city 107A to purchase land in the vicinity of the portal 115E in order to avoid city congestion, noise, pollution, inadequate schools, crime, etc. However, such increase in population density may correspondingly increase traffic demand.

The topology of the transportation network 101 is influenced by a number of factors. For example, the suburb 109E may be connected to the road 111I that leads to the portal 115E. One of skill in the art will appreciate how the use of roads to and from the suburb 109E is minimal due to (1) the proximity of the portal 115E and (2) the suburb 109E being built with the portal 115E as a primary mode of transportation for the area. Therefore, the inhabitants of suburb 109E largely rely on hyperloop for their transportation needs when traveling beyond the nearby area of the suburb 109E. As such, the inhabitants of the suburb 109E may rely on fewer transportation modes. In contrast, the inhabitants of city 107A have multiple points of access to roads and hyperloop routes. Such considerations may affect traffic demand viz. inhabitants in the suburb 109E may place more demand on the hyperloop routes in the vicinity of the suburb 109E compared to roads in the same area.

A hyperloop portal 115F is positioned substantially near the airport 122A to illustrate that in some implementations, a portal may be tightly coupled to a nearby location. In the instant example, the airport 122A may unload passengers, near the portal 115F, directly into hyperloop pods traveling toward the city 107A. A portal 115G is shown as being tightly coupled to the port 119A. In one aspect, cargo ships docking at the port 119A may unload cargo containers bound for the city 107A. Prior to the introduction of the portal 115G, cargo had to be caned via the road 111E using traditional semi-trucks. Therefore, autonomous operation of the hyperloop pods may reduce road-based traffic. Further, a human operator may utilize the disclosed solution to manage, control, and operate the hyperloop network 104.

The route 113G connects the portal 115G to the portal 115B. The route 113G may be specially configured to carry cargo-laden pods, that are destined for the city 107A, in one aspect. In another aspect, the pods traveling along the route 113G may be a mix of passenger-configured and cargo-configured pods. The route 113F connects the portal 115G to the portal 115F and may be utilized for a combination of passenger and cargo traffic. For instance, passengers may arrive at the airport 122A, enter the portal 115F, travel via the route 113F to the portal 115G, and finally travel along the route 113G to arrive at the portal 115B. In another example, cargo may be offloaded from airplane at the airport 122A and then be transported to the port 119A via the route 113F. Likewise, the cargo may be transported between the port 119A and the city 107A (or to any other destination).

FIG. 1B is a block diagram illustrating the transportation network 101. The instant figure is substantially similar to FIG. 1A above. However, some reference labels have been omitted in order to further illustrate the disclosed solution as operating on a real-world example. One of skill in the art will appreciate that the unlabeled parts still maintain the same references as described above in FIG. 1A.

FIG. 1C is a block diagram illustrating the transportation network 101. The instant figure is substantially similar to FIG. 1A above. However, some reference labels have been omitted in order to further illustrate the disclosed solution as operating on a real-world example. One of skill in the art will appreciate that the unlabeled parts still maintain the same references as described above in FIG. 1A.

FIG. 1D is a block diagram illustrating the transportation network 101. The instant figure is substantially similar to FIG. 1A above. However, some reference labels have been omitted in order to further illustrate the disclosed solution as operating on a real-world example. One of skill in the art will appreciate that the unlabeled parts still maintain the same references as described above in FIG. 1A.

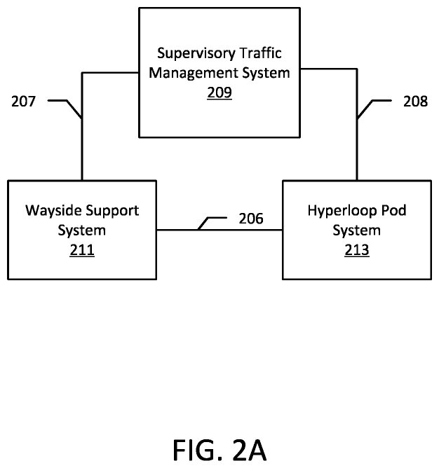

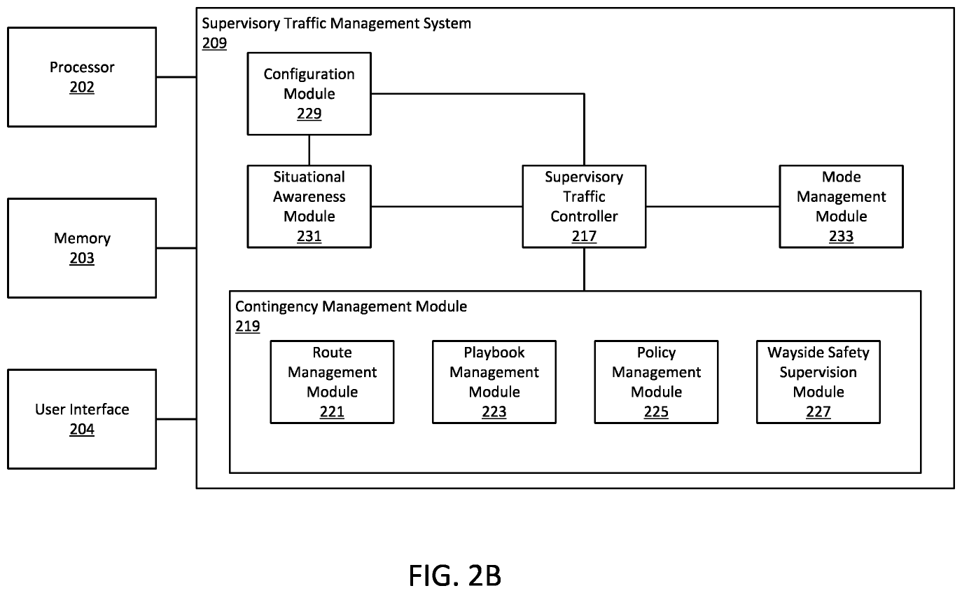

FIG. 2A is a block diagram of a supervisory traffic management system 209, a wayside support system 211, and a hyperloop pod system 213. The wayside support system 211 is in communication with the hyperloop pod system 213 via a first link 206. The supervisory traffic management system 209 is in communication, via a second link 207, with the wayside support system 211. The supervisory traffic management system 209 is in communication, via a third link 208, with the hyperloop pod system 213. The links 206, 207, 208 may be implemented in a number of manners. In one aspect, the links 206, 207, 208 may be physical communication lines disposed along the wayside of a hyperloop route. In another aspect, the links 206, 207, 208 may be wireless, operating via high-speed cellular communication, transponder-based communication, or a combination thereof. In still another aspect, the links 206, 207, 208 may be logical links embodied in a combination of hardware and software.

The wayside support system 211 is generally utilized to manage a plurality of transponders disposed at or near a hyperloop route (e.g., the plurality of routes 113N), consisting of a plurality of track and tubes. In one aspect, the wayside support system 211 may utilize a transponder to communicate travel-related information between the hyperloop pod system 213 (e.g., current velocity and position of downstream pods). In another aspect, the wayside support system 211 may provide high-speed communication to the hyperloop pod system 213 for data that relates to non-critical operations (e.g., infotainment for onboard passengers). In still another aspect, the high-speed communication may be utilized by the supervisory traffic management system 209 to communicate policies, plays, operations, commands, etc. to the hyperloop pod system 213 (e.g., prioritization of passenger travel over cargo shipments).

The hyperloop pod system 213 is generally configured to manage the operations of a hyperloop pod that is operating in the hyperloop network 104. In one aspect, the hyperloop pod system 213 may be substantially autonomous wherein the hyperloop pod is configured to perform operations relating to locomotion and navigation with minimized human interaction. For instance, the hyperloop pod system 213 may be configured to cause a hyperloop pod to depart a hyperloop portal, travel along a hyperloop route, and arrive at a destination hyperloop portal (e.g., the portal 115C). Further, such operations may be performed with reduced human interaction.

The supervisory traffic management system 209 is generally configured to provide human interaction for the management of the hyperloop network 104. In one aspect, the supervisory traffic management system 209 may provide a user interface for use by operators managing the operation of the hyperloop network 104. For example, the user interface may be a control panel configured to be presented on a computing device using a mouse and a keyboard. The supervisory traffic management system 209 may send a combination of operations to the hyperloop pod system 213 (e.g., operations to cause a hyperloop pod to enter a portal for maintenance). One of skill in the art will appreciate that the supervisory traffic management system 209 may rely on human operators whereas the hyperloop pod system 213 may rely on substantially autonomous systems.

FIG. 2B is a block diagram of the supervisory traffic management system 209, shown in more detail. The supervisory traffic management system 209 is in communication with a processor 202, a memory 203, and a user interface 204. The processor 202 may be a general-purpose processor, an application specific integrated circuit (“ASIC”), a fully programable gate array, etc. The memory 203 may be volatile, non-volatile or a combination thereof. The user interface 204 may be a software program executing on the processor 202 and being stored in the memory 203. In one aspect, the user interface 204 may be a graphical user interface operating on a touchscreen display. In another aspect, a computing device using a mouse and a keyboard may be utilized as the user interface 204.

The supervisory traffic management system 209 has a configuration module 229, a situational awareness module 231, a supervisory traffic controller 217, a mode management module 233, and a contingency module 219. The configuration module 229 is generally utilized to update system configurations, in one aspect. In another aspect, the configuration module 229 may change operating policies. In yet another aspect, the configuration module 229 may configure software operating on the supervisory traffic management system 209. In another aspect, the configuration module 229 may communicate with the wayside support system 211.

The situational awareness module 231 is generally configured to discern the operational state, in one aspect. In another aspect, the situational awareness module 231 may be utilized to determine conditions and risks within the hyperloop network 104. Such conditions and risks may further be augmented by recommendations.

The supervisory traffic controller 217 is generally configured to present a human-machine interface to display interactive control information to a human operator. In one aspect, the supervisory traffic controller 217 is configured to present real-time operational data as reported by elements (e.g., transponders) within the hyperloop network 104. In another aspect, the supervisory traffic controller 217 presents risks detected in the hyperloop network 104. In still another aspect, the supervisory traffic controller 217 may provide recommendations, as well as expected outcomes, to a human operator. One of skill in the art will appreciate that having such decision support for human operators provides an efficient and effective means to address complex problems that human operators cannot easily understand without machine intelligence.

The mode management module 233 is generally configured to transition hyperloop pods in and out of service within the hyperloop network 104. In one aspect, the mode management module 233 invokes a change in pod service states (e.g., from “in operation” to “out of operation”) such that the supervisory traffic management system 209 may propagate such information to other elements supervising the hyperloop network 104 (e.g., transponders along the wayside).

The contingency module 219 has a route management module 221, a playbook management module 223, a policy management module 225, and a wayside safety supervision module 227. The contingency module 219 is generally configured to monitor and direct pods within a hyperloop portal (e.g., the plurality of portals 115N). In one aspect, a portal may be what is often referred to as a “depot” wherein hyperloop pods are stored, maintained, placed in service, removed from service, stabled, unstabled, etc. In one aspect, the contingency module 219 manages the arrival and departure of hyperloop pods. In another aspect, the contingency module 219 places the hyperloop pods in storage, often referred to as “stabling.” In yet another aspect, the contingency module 219 may resolve contingent decisions. For example, the contingency module 219 may be configured to resolve a deadlock situation where action is required to release deadlocked elements (e.g., two hyperloop pods requesting the same resource at substantially the same time interval).

The route management module 221 is generally configured to direct the movements of hyperloop pods within the hyperloop network 104. In one aspect, the route management module 221 is configurable by the operator such that the movements of the hyperloop pods may be executed according to a set of operations selected by or approved by the operator. Further, the set of operations may be referred to as a “play.” As such, a play may be invoked by the route management module 221 to effect the movement of a hyperloop pod.

The playbook management module 223 is generally configured to store one or more plays. In one aspect, a play may contain information and constraints relating to traffic restrictions. For instance, as shown in FIG. 1B, the route 113B may have a maximum allowed velocity of 500 km/h compared with route 113C which has a maximum velocity of 400 km/h. In another aspect, the play is configured to control infrastructure elements to carry out the movement operations of the play. For example, in FIG. 1C above, the play may unlock additional pod bays at the portal 115F during a holiday weekend such that pods may have faster throughput in dropping off passengers. In one aspect, the playbook management module 223 and the associated plays may be created, stored, and executed at the direction of a human operator.

The policy management module 225 is generally configured to modify global restrictions and operational parameters to control overall mode or expression of mode of transportation. The policy management module 225 contains a set of operations associated with the operational parameters, in one aspect. In another aspect, the policy management module 225 stores the expression of mode of transportation in a policy. As described above with respect to the mode management module 233, hyperloop pods may be added to and removed from service. A policy is configured such that the manner and method of said addition or removal is performed according to a designated policy. For example, a policy may state that any hyperloop pod with a battery system that carries a maximum charge of 80% of total capacity is to be removed from service as soon as possible. In one aspect, a policy is a combination of a play, operational parameters, and global restrictions. The policy may cause a play to be constrained such that the play conforms to the parameters and data in the policy.

The wayside safety supervision module 227 is generally configured to monitor the status of wayside elements (e.g., vacuum systems, transponders, tube structure, etc.). In one aspect, the wayside safety supervision module 227 utilizes the wayside support system 211 to monitor the wayside elements. In one aspect, the supervisory traffic controller 217 presents information relating to the current position and velocity of the pods operating in the hyperloop network 104 such that human operators may visually see the status of the hyperloop network 104 in operation.

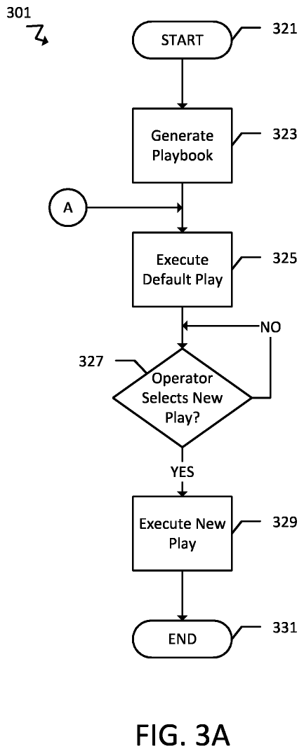

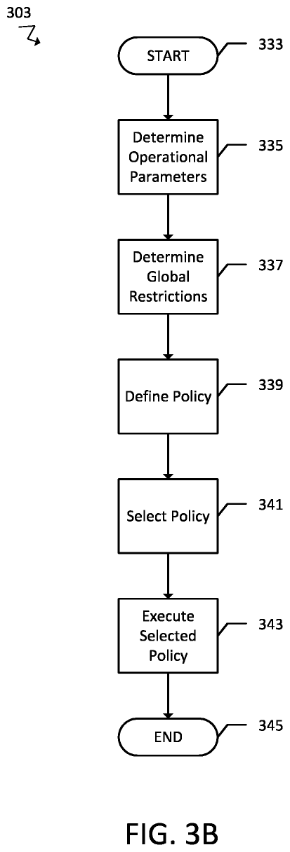

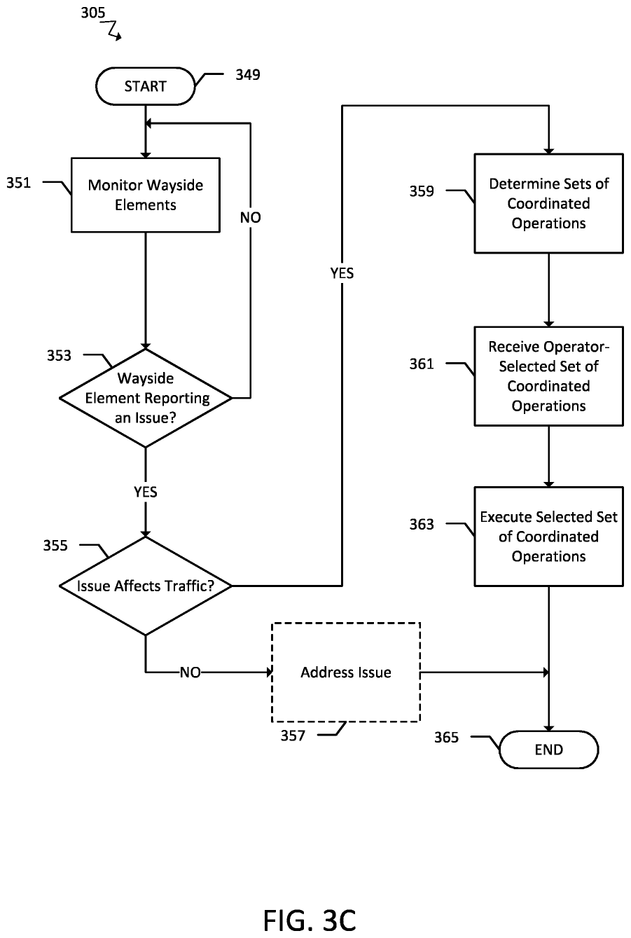

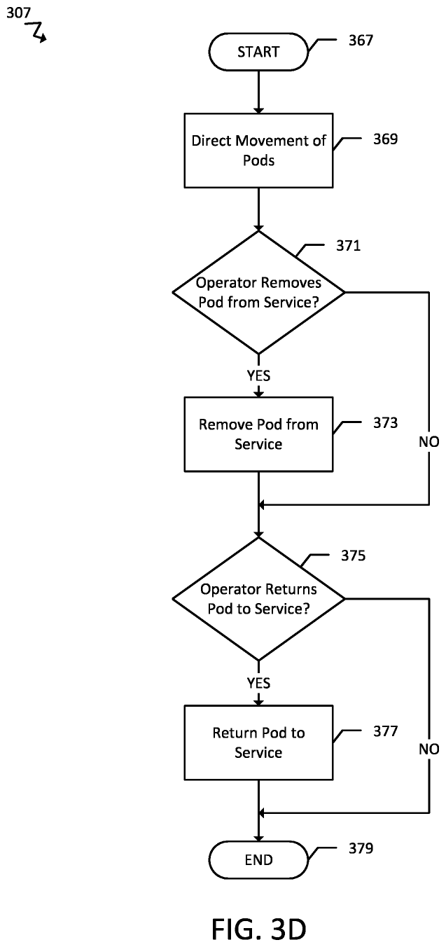

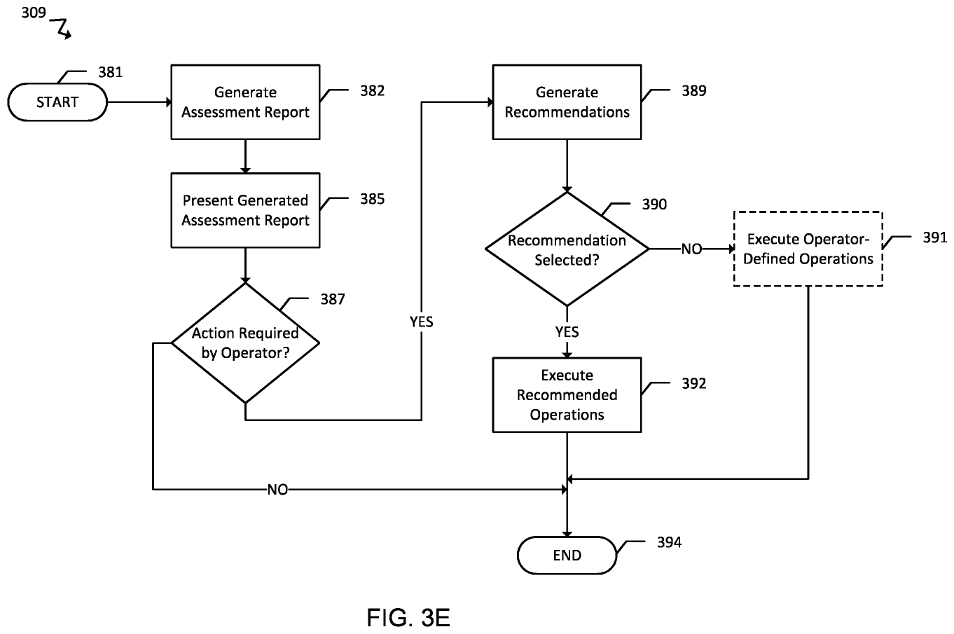

FIG. 3A is a flowchart of a process 301 for executing a play from a playbook associated with the hyperloop network 104. The process 301 begins at the start block 321 and proceeds to the block 323 where the process 301 generates a playbook. The playbook management module 223 presents a graphical interface via the supervisory traffic controller 217 such that a human operator may create a play. Further, the human operator may create several plays for storage within the playbook management module 223 (that is stored in a memory). In one aspect, the operator sets a default play to be executed upon initialization of the supervisory traffic management system 209. The process 301 then proceeds to the block 325.

At the block 325, the process 301 executes a default play. The default play may have been set at the block 323 or at an earlier point in time (e.g., as predetermined by default values stored in a computer program or by a predetermined policy). The process 301 then proceeds to the decision block 327.

At the decision block 327, the process 301 determines whether the operator has selected a new play from the playbook. The playbook management module 223 coordinates with the supervisory traffic controller 217 to provide a user interface for the human operator to select a play to execute (e.g., via the user interface 204). If the process 301 determines that the operator has not selected a new play from the playbook, the process 301 proceeds along the NO branch, thus returning to the decision block 327. If the process 301 determines that the operator has selected a new play from the playbook, the process 301 proceeds along the YES branch to the block 329.

At the block 329, the process 301 executes a new play from the playbook. In one aspect, the play may relate to a coordinated set of operations relating to one or more pods. For example, in FIG. 1D above, the process 301 routes additional pods to the route 113A during rush hour because the suburbs 109A, 109B have many inhabitants who commute from the suburbs 109A, 109B to the city 107A. The process 301 then proceeds to the end block 331 and terminates.

In one aspect, the process 301 may resume or start at the reference A in the instant figure. For example, if the plays are already generated, the process 301 may simply be operating with the generated plays in which case no additional plays need to be generated at that time. Likewise, a policy may be so constrictive that the plays are rarely altered from an initial state.

FIG. 3B is a flowchart of a process 303 for executing a policy associated with the hyperloop network 104. The process 303 begins at the start block 333 and proceeds to the block 335. At the block 335, the process 303 determines operational parameters. The operational parameters may relate to many elements of the hyperloop network 104. For example, the operational parameters relate to the number of pods in service, the number of docking bays available in a portal, the number of first-class passengers allowed within a pod during rush hour, the maintenance event cadence for a segment of tube, the minimal charge level in a pod, the top velocity of a pod, the cargo capacity of a pod, the number of junctions in a route, etc. The process 303 then proceeds to the block 337.

At the block 337, the process 303 determines global restrictions. An example of a global restriction may be related to traffic parameters—for instance, the amount of braking margin required by hyperloop pods operating within the hyperloop network 104. Such a braking margin is an example of a parameter that human operators may desire to manually set because an incorrect value can lead to catastrophic loss of life. Examples of global restrictions include: top velocity, minimum velocity, top acceleration, minimal acceleration, turning speed, braking force, maximum roll, maximum pitch, maximum yaw, convoy size, convoy count, no travel zones/routes, maintenance hours/intervals, etc. The process 303 then proceeds to the block 339.

At the block 339, the process 303 defines a policy. One of skill in the art will appreciate that a policy may relate to any parameter relating to the operation of elements within the hyperloop network. In one aspect, the policy expresses any operation of the supervisory traffic management system 209 that is not inconsistent with a global restriction. For example, a global restriction may require that no pods travel during the hours of 01:00 to 02:00 via the route 113E because maintenance is scheduled at that time. As such, a policy may direct the schedules and operations of the route 113E to times outside the hours of 01:00 to 02:00. Thus, a policy may effectively limit a particular play. The process 303 then proceeds to the block 341.

At the block 341, the process 303 selects a policy. In one aspect, the policy management module 225 communicates with the supervisory traffic controller 217 such that a graphical user interface is presented with which a human operator may select a policy (e.g., via the user interface 204). The process 303 then proceeds to the block 343. At the block 343, the process 303 executes the selected policy. The process 303 then proceeds to the end block 345 and terminates.

FIG. 3C is a flowchart of a process 305 for executing a set of coordinated operations in response to monitoring wayside elements. The process 305 begins at the start block 349 and proceeds to the block 351. At the block 351, the process 305 monitors wayside elements using the wayside safety supervision module 227. In one aspect, the wayside safety supervision module 227 is in communication with the wayside support system 211. The process 305 then proceeds to the decision block 353.

At the decision block 353, the process 305 determines whether a wayside element is reporting an issue. If the wayside element is not reporting an issue, the process 305 proceeds along the NO branch to the block 351. Returning to the decision block 353, if the process 305 determines that a wayside element is reporting an issue, the process 305 proceeds along the YES branch to the decision block 355.

At the decision block 355, the process 305 determines whether the reported issue affects traffic. Non-traffic-related issues may be separated from traffic-related issues by the supervisory traffic management system 209. To do so, the supervisory traffic management system 209 utilizes the functionality of the situational awareness module 231, the contingency management module 219, or a combination thereof. If the process 305 determines that the issue does not affect traffic, the process 305 proceeds along the NO branch to the block 357.

At the block 357, the process 305 addresses the issue. Given that the issue is non-traffic-related, another system, subsystem, module, etc. may be better configured to address the issue. As such, the block 357 is denoted with dashes to indicate optionality. The process 305 then proceeds to the end block 365 and terminates. Returning to the decision block 355, if the issue is determined to affect traffic, the process 305 then proceeds via the YES branch to the block 359.

At the block 359, the process 305 determines a set of coordinated operations. In one aspect, the set of coordinated operations are a play managed by the playbook module 223. In another aspect, the set of coordinated operations may be a set of manually input operations. The process 305 then proceeds to the block 361.

At the block 361, the process 305 receives an operator-selected set of coordinated operations. In one aspect, the supervisory traffic controller 217 may present a graphical user interface via the user interface 204 in order to receive the input from a human operator. The process 305 then proceeds to the block 363. At the block 363, the process 305 executes the selected set of coordinated operations. The process 305 then proceeds to the end block 365 and terminates.

FIG. 3D is a flowchart of a process 307 for directing the movement of hyperloop pods. The process 307 begins at the start block 367 and proceeds to the block 369. At the block 369, the process 307 directs movement of hyperloop pods. In one aspect, the mode management module 233 is utilized to direct the movement of hyperloop pods in the hyperloop network 104. In one aspect, the hyperloop pods may be directed according to a play managed by the playbook management module 223. The process 307 then proceeds to the decision block 371.

At the decision block 371, the process 307 determines whether the operator has entered operations to remove a targeted pod from service. In one aspect, the operator may enter operations via the supervisory traffic controller 217 to adjust the number of pods in service. If a pod is not removed from service, the process 307 then proceeds along the NO branch to the decision block 375. Returning to the decision block 371, if the operator has entered operations to remove the targeted pod from service, the process 307 then proceeds along the YES branch to the block 373.

At the block 373, the process 307 removes the targeted pod from service. In one aspect, the mode management module 233 communicates with the hyperloop pod system 213 to remove one or more pods from service via a plurality of operations (that include substantially autonomous commands). The process 307 then proceeds to the decision block 375.

At the decision block 375, the process 307 determines whether the operator has entered operations to return a targeted pod to service. In one aspect, the human operator utilizes the user interface 204 to enter operations via the supervisory traffic controller 217 in order to select and remove a pod from service. If a pod is not commanded to return to service, the process 307 then proceeds along the NO branch to the end block 379 and terminates.

Returning to the decision block 375, if the pod is commanded to return to service, the process 307 proceeds along the YES branch to the block 377. At the block 377, the process 307 returns the pod to service by operation of the mode management module 233. In one aspect, the mode management module 233 may communicate with the hyperloop pod system 213 in order to invoke the set of substantially autonomous operations to guide the pod back into service.

FIG. 3E is a flowchart of a process 309 for generating and selecting a recommended set of operations. The process 309 begins at the start block 381 and proceeds to the block 382. At the block 382, the process 309 generates an assessment report. The assessment report is generated based on data within the supervisory traffic management system 209 as stored in the memory 203. The assessment report identifies risks and issues that an operator may consider as part of operating the hyperloop network 104. For example, the assessment report visually displays the overall battery health of a fleet of pods such that the operator may determine maintenance scheduling and associated operations. The process 309 then proceeds to the block 385.

At the block 385, the process 309 presents the generated assessment report. In one aspect, the supervisory traffic controller 217 presents a graphical user interface via the user interface 204. The process 309 then proceeds to the decision block 387.

At the decision block 387, the process 309 determines whether action is required by the operator. Some assessment reports may indicate that no issues require action by the operator. In one aspect, the operator may have defined, via the policy management module 225, thresholds and parameters that affect what is and is not considered an issue according to a policy. An issue may be related to safety, maintenance, traffic, etc. If no action is required by the operator, the process 309 proceeds along the NO branch to the end block 394 and terminates.

Returning to the decision block 387, if the process 309 determines that action is required by the operator, the process 309 then proceeds along the YES branch to the block 389. At the block 389, the process 309 generates recommendations. In one aspect, the recommendations are presented on the user interface 204 via the supervisory traffic controller 217. For example, a graphical interface provides an operator with the criticality of an issue as well as the cost to address said issue. The process 309 then proceeds to the decision block 390.

At the decision block 390, the process 309 determines whether a recommendation was selected. If the recommendation was not selected, the process 309 proceeds along the NO branch to the block 391.

At the block 391, the process 309 executes operator-defined operations. The block 391 is denoted in dashed lines in the instant figure to indicate the optional nature of block 391 as the operator may simply discard the recommendation and take no action. The operator may have previously defined a play in the playbook management module 223 to assist with the execution of operator-defined operations. Returning to the decision block 390, if a recommendation was selected, the process 309 proceeds along the YES branch to the block 392. At the block 392, the process 309 executes recommended operations (which may be one or more plays). The process 309 then proceeds to the end block 394 and terminates.

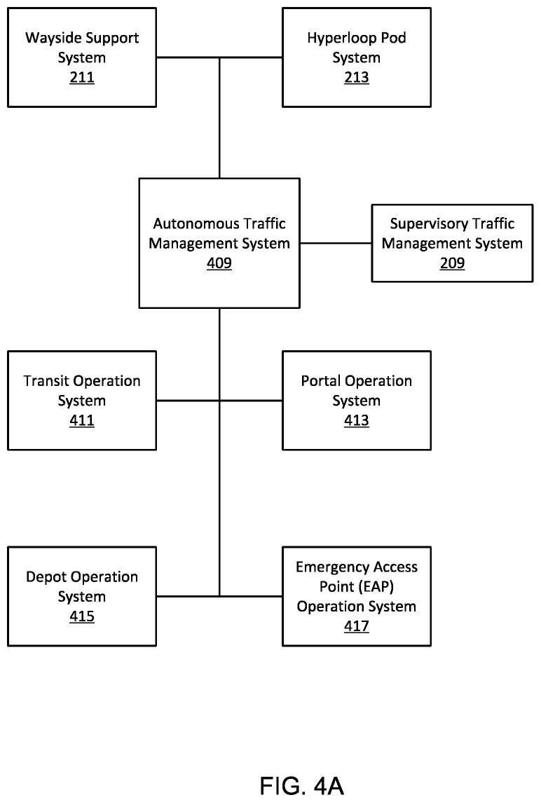

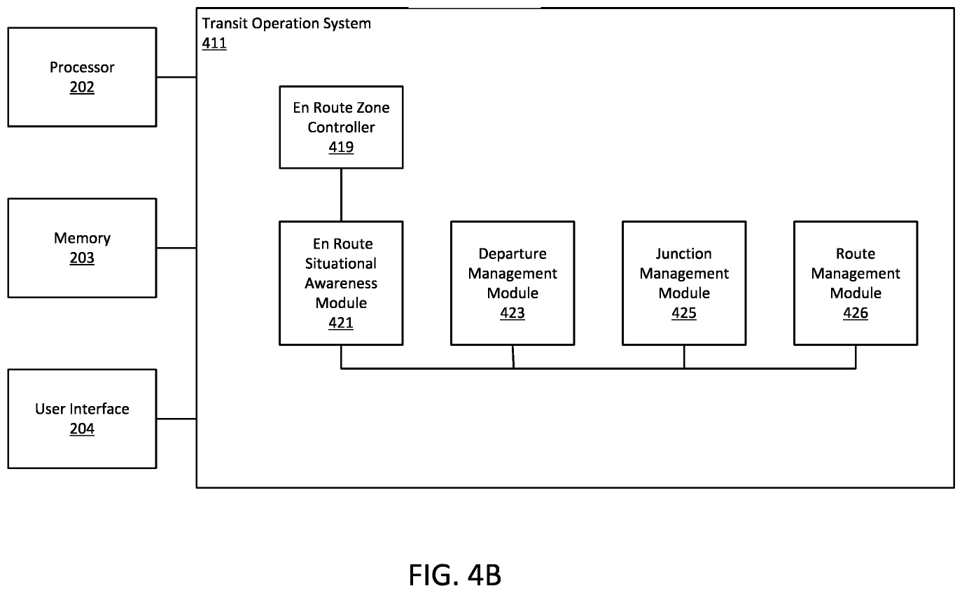

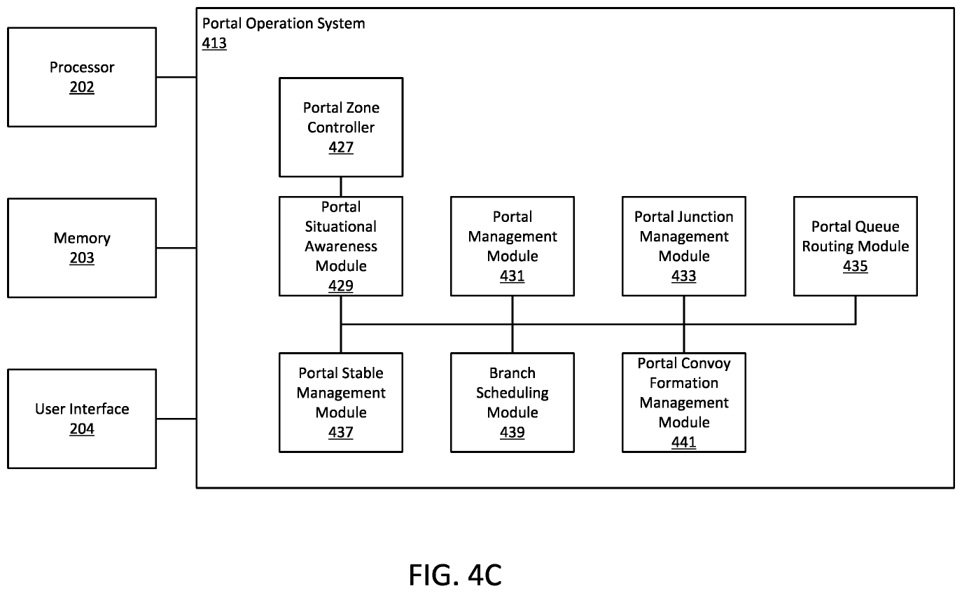

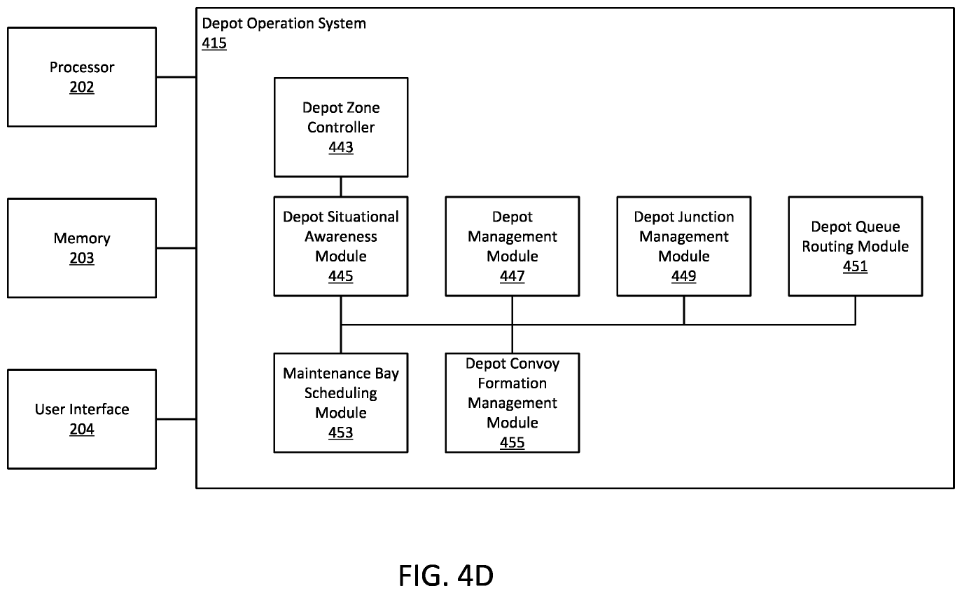

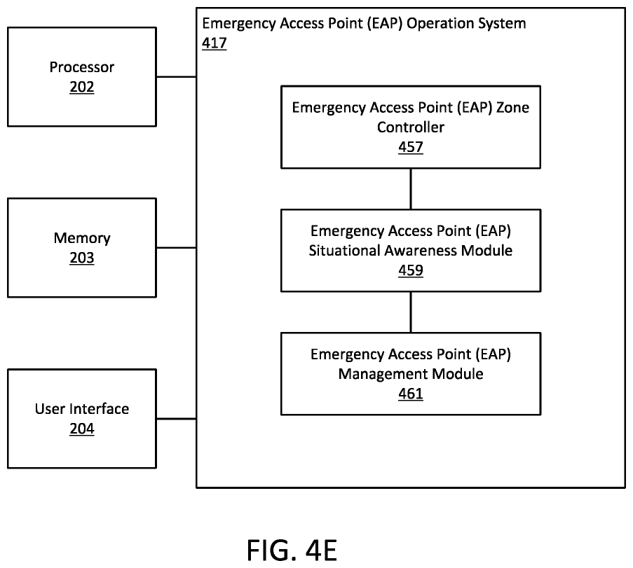

FIG. 4A is a block diagram of an autonomous traffic management system 409, the supervisory traffic management system 209, a wayside support system 411, a hyperloop pod system 213, a transit operation system 411, a portal operation system 413, a depot operation system 415, and an emergency access point (“EAP”) operation system 417. The autonomous traffic management system 409 is generally configured to manage traffic within the hyperloop network 104. In one aspect, the autonomous traffic management system 409 may coordinate the operation of several hyperloop pods via the hyperloop pod system 213 disposed within each of the pods. The autonomous traffic management system 409 relies on a number of systems and modules (e.g., the portal operation system 413) to effect the management of the hyperloop network 104, thus providing enhanced safety and reliability. High-speed communication may be utilized, via the wayside support system 211, by the autonomous traffic management system 409 to communicate policies, operations, commands, etc. to the hyperloop pod system 213 (e.g., maximum pod velocities).

The supervisory traffic management system 209 is shown as being coupled to the autonomous traffic management system 409 such that a human operator may control the autonomous operations of the hyperloop network 104. As such, the disclosure of FIG. 2A through FIG. 3E are applicable to the operation of the supervisory traffic management system 209 with respect to the autonomous traffic management system 409. One of skill in the art will appreciate that the autonomous traffic management system 409 is substantially autonomous whereas the supervisory traffic management system 209 is substantially human-operated. The hybrid approach to managing the hyperloop network 104 enables the best of both approaches because human intelligence is necessary for some decisions (e.g. complex contingency handling, off-nominal operations, system mode switching, fare pricing, maintenance scheduling, etc.) whereas autonomous operations are required for certain situations (e.g., high-level scheduling of pods, minimizing operational costs, autonomous portal operations, autonomous depot operations, nominal pod trajectory deconfliction, minimizing passenger wait times, etc.).

The transit operation system 411 is generally configured to monitor and direct hyperloop pods that are operating en route within the hyperloop network 104. In one aspect, the transit operation system 411 may be configured to resolve contingent situations. For example, if two pods are going to collide at a junction, the transit operation system 411 is configured to resolve the conflict such that collision is avoided.

The portal operation system 413 is generally configured to monitor and direct hyperloop pods operating within a portal. For example, in FIG. 1B, a hyperloop pod may travel via the route 113E and arrive at the portal 115F, nearby the airport 122A. The portal operation system 413 is configured to direct the pod to the correct loading bay such that passengers may disembark near a tram that will carry the passengers to a security gate.

In another aspect, the portal operation system 413 is configured to manage departure of pods leaving a portal. For example, in FIG. 1C, the portal operation system 413 may be configured to launch a pod from the portal 115G into the route 113G such that the hyperloop pod may reach the city 107A. The portal operation system 413 is configured to create a convoy of departing pods. In one aspect, the convoy may be created in order to resolve a potential conflict at a branch within the portal.

In yet another aspect, the portal operation system 413 is configured to manage the stabling of pods. One of skill in the art will appreciate that many pods may be in operation within the hyperloop network 104 at any given time. However, some pods may be stabled such that additional pods are added to or removed from the hyperloop network 104. For example, in FIG. 1D, during rush hour, additional pods may be deployed from the portal 115B to meet the demand along the route 113A such that commuters from the city 107A may reach homes within the suburbs 109A, 109B, 109C. Likewise, additional pods may be removed from service after rush hour and then stabled at the portal 115A.

In yet another aspect, the portal operation system 413 is configured to resolve contingent situations. For example, in FIG. 1B, a hyperloop pod may be traveling from the portal 115D to the portal 115E. If the docking bays are currently filled at the portal 115E while the pod is en route to the portal 115E, the portal operation system 413 resolves the contingent situation by causing a docked pod to depart from the portal 115E prior to the arrival of the incoming pod. In one aspect, the portal operation system 413 may create a convoy of departing pods.

The depot operation system 415 is generally configured to manage a depot that is configured to send pods into the hyperloop network 104 as well as receive pods from the hyperloop network 104. A depot is similar to a portal with the difference of a portal being designed to enable passengers and cargo to load into a hyperloop pod and unload from a hyperloop pod. In contrast, a depot may be more focused on managing the pods. For instance, the portal 115C may also house a depot (not shown) that is configured to perform routine maintenance on hyperloop pods. In one aspect, the operations of the portal operation system 413 and the depot operation system 415 may be similar in that both launch and receive pods. However, the systems 413, 415 are depicted separately in the instant figure to highlight the different use cases relating to the management of pods within a portal versus a depot.

The EAP operation system 417 is generally configured to monitor and direct pods to revolve contingent situations, including emergency situations. A hyperloop pod may experience a malfunction while operating on a route. For example, in FIG. 1C, a hyperloop pod may depart the portal 115G carrying cargo from the port 119A to the portal 115F, near the airport 122A. Further, the hyperloop pod may lose power while traveling along the route 113F and be forced to stop. The EAP operation system 417 may take action to reroute other hyperloop pods such that a collision is avoided. Further, the EAP operation system 417 resolves other contingent situations related to the malfunction. For example, the EAP operation system 417 may cause maintenance and emergency crews to be dispatched to the halted pod such that the hyperloop network 104 may resume operations.

FIG. 4B is a block diagram of the transit operation system 411. The transit operation system 411 has an en route zone controller 419, an en route situational awareness module 421, a departure management module 423, a junction management module 425, and a route management module 426. The en route zone controller 419 is generally configured to manage data collection and communication between the wayside support system 411 and the autonomous traffic management system 409.

The en route situational awareness module 421 is generally configured to determine operational states of the autonomous traffic management system 409. In one aspect, the en route situational awareness module 421 is configured to determine conditions and risks within the hyperloop network 104. For example, in FIG. 1B, the en route situational awareness module 421 determines whether the route 113H is experiencing reduced throughput due to a maintenance issue in the loading bays of the portal 115F near the airport 122A.

The departure management module 423 is generally configured to determine the space-time windows of hyperloop pod departure assignments and/or arrival assignments. In one aspect, the departure management module 423 is configured to address conflicts arising between two or more hyperloop pods having conflicting scheduling requirements. Further, the departure management module 423 is configured to take into account the time and velocity deltas between two hyperloop pods such that a conflict can be resolved. One of skill in the art will appreciate that resolution of conflicts enhances both safety and efficiency of the hyperloop network 104.

The junction management module 425 is generally configured to address conflicts arising between two or more hyperloop pods having a conflict at a junction. For example, in FIG. 1C, the routes 113C, 113D may have a junction (or branch) in the portal 115D. The junction management module 425 is configured to resolve a conflict related to pods being blocked by a conflict at the junction. In one aspect, the junction management module 425 takes into account an unsuccessful high-speed conflict resolution and uses the resulting data to inform a conflict resolution based on the information within the junction management module 425. In another aspect, the junction management module 425 may determine the conflict resolution according to a predetermined policy set by the operator of the hyperloop network 104. For example, the hyperloop operator may have a policy to prioritize cargo-carrying pods over passenger-carrying pods with respect to determining rights-of-way at a junction (or branch). The route management module 426 is generally configured to direct pods according to supervisory traffic management system 209, i.e., by mapping and executing plays from a playbook.

FIG. 4C is a block diagram of the portal operation system 413. The portal operation system 413 has a portal zone controller 427, a portal situational awareness module 429, a portal management module 431, a portal junction management module 433, a portal queue routing module 435, a portal stable management module 437, a branch scheduling module 439, and a portal convoy formation management module 441.

The portal operation system 413 is generally configured to autonomously manage a portal. For example, in the FIG. 1D, the portal operation system 413 manages the portals 115A, 115B such that rush hour traffic between the city 107A and the suburbs 109A, 109B, 109C is carried out in an efficient and safe manner. One of skill in the art will appreciate that the portal operation system 413 may be configured to manage several portals (e.g., the plurality of portals 115N) such that the entire hyperloop network 104 operates in a coordinated manner wherein efficiency and safety are increased.

The portal zone controller 427 is generally configured to manage portal-related communication between the hyperloop pod system 213 and the wayside support system 411. In one aspect, the portal zone controller 427 may be configured to collect data relating to the hyperloop pod system 213 interacting with elements within a portal. For example, in the FIG. 1B, the portal zone controller 427 is configured to gather data from the hyperloop pod system 213 and the portal 115C as the hyperloop pod arrives from the portal 115B.

The portal situational awareness module 429 is generally configured to discern operational states, conditions, and risks within the portal. A portal has a number of operational states relating to the status of docked pods, departing pods, arriving pods, etc. The portal situational awareness module 429 is configured to collect data relating to the operational states as relating to the conditions within the portal. For example, a portal may be experiencing a particularly unusual amount of traffic due to a sporting event. As such, the portal situational awareness module 429 collects data from sensors within the portal in order to determine actions for resolving existing and potential conflicts.

In one aspect, the portal situational awareness module 429 is configured to detect and mitigate risks to the portal. For example, the portal situational awareness module 429 gathers information from sensors. If a sensor indicates a foreign object is near the rail, the portal situational awareness module 429 informs the autonomous traffic management system 409 that a risk is present within the portal in order that the risk may be addressed and mitigated.

The portal management module 431 is generally configured to direct movements of pods within the portal according to a policy or play. A human operator may predetermine a number of policies that act in concert with the portal operation system 413. For example, a policy may be to remove a pod from service if the pod arrives at a portal with a peak battery charge level that is lower than a desired threshold (e.g., 80%).

The portal junction management module 433 is generally configured to provide control and resolution of conflicts at junctions within a portal. In one aspect, the portal junction management module 433 resolves conflicts according to a predetermined policy that has been set by the human operator of the hyperloop network 104. For instance, the policy may state that, given two pods approaching a junction, the pod carrying more passengers is prioritized for travel through the junction.

The portal queue routing module 435 is generally configured to direct pods to appropriate queues in order to facilitate convoy formation. A queue may be a sequence of pods arranged, either logically or physically, in a predetermined order. As the pods depart, the pods may form a convoy along a particular route. For example, in the FIG. 1C, a queue of pods is generated at the portal 115F for arriving passengers as airplanes land at the airport 122A. Once the pods depart along the route 113H to the city 107A, the pods logically and physically form a convoy. In another example, the same pods may form a logical queue but may physically depart along the routes 113E, 113F, 113H while still having a logical relationship.

The portal stable management module 437 is generally configured to manage the allocation of pods, the storage of pods, the access to pods, and the distribution of pods at the plurality of portals 113N such that scheduling requirements are met. For example, in FIG. 1C, a number of ships may dock at the port 119A. When the cargo is unloaded, a number of additional pods are required to receive and transport the cargo to a final destination. As such, the portal stable management module 437 causes additional pods to leave a stable within the portal 115G and accept the arriving cargo.

The branch scheduling module 439 is generally configured to manage allocation of available pod bays to a departure schedule and/or arrival schedule. A hyperloop pod generally requires a loading bay to load and unload passengers and/or cargo. Given that loading bays are finite within a particular portal, the branch scheduling module 439 is generally configured to allocate the loading bays such that the related scheduling requirements are satisfied. In the event that scheduling events are not satisfied, the branch scheduling module 439 is configured to prioritize the loading bays according to a predetermined policy, previously set by a human operator of the hyperloop network 104 (via use of the supervisory traffic management system 209).

The portal convoy formation management module 441 is generally configured to generate formations of pods as convoys. In one aspect, the convoys may be physical, i.e., the pod physically moves along a route in sequence related to other pods. In another aspect, the convoys may be logical, i.e., the pods are logically arranged in a sequence that is not physical in nature. For example, a logical convoy may be a plurality of pods set up to depart along two different branches, with an understanding that the pods will arrive one before another at a destination, thus being a logical convoy.

FIG. 4D is a block diagram of the depot operation system 415. The depot operation system 415 comprises a depot zone controller 443, a depot situational awareness module 445, a depot management module 447, a depot junction management module 449, a depot queue routing module 451, a maintenance bay scheduling module 453, and a depot convoy formation management module 455.

The depot zone controller 443 is generally configured to manage data collection, communication, and control commands transmitted between the hyperloop pod system 213 and the wayside support system 211 as related to operation at or near a depot. For simplicity in FIG. 1A through FIG. 1D, the plurality of portals 113N are depicted the same. However, a portal may be a depot or contain a depot therein. At a high level, a depot is configured to manage hyperloop pods such that the pods may be stored, repaired, maintained, replaced, removed from service, added to service, etc. The depot zone controller 443 sends control commands to the hyperloop pod system 213 such that the associated pod may navigate within a depot.

The depot situational awareness module 445 is generally configured to discern operational states, conditions, and risks within the depot. A depot, like a portal, may have an operational state relating to the number of pods docked, the number of pods being repaired, the number of pods being maintained, the number of pods being added to service, the number of pods being removed from service, departure schedules, arrival schedules, emergency situations, etc.

The depot management module 447 is generally configured to direct movement of pods within a depot according to a predetermined policy. For instance, a policy may state that pods having any fuselage damage be extracted from the depot such that the pod may be destroyed and salvaged. In such a case, the depot management module 447 utilizes information gathered from sensors and/or human operators such that pods subject to the policy are removed when fuselage damage is detected.

The depot junction management module 449 is generally configured to provide control of pods traveling through junctions (or branches) at the depot. A particular depot may have a number of junctions (or branches). For example, a depot may have a series of junctions (or branches) that each feed into a loading bay. The depot junction management module 449 may, in one aspect, determine how the pods behave when approaching or reaching a junction (or branch).

In one aspect, the depot junction management module 449 may be configured to address conflicts. For example, a particular junction (or branch) may serve several loading bays. If one or more pods require access via the junction (or branch), the depot junction management module 449 is configured to detect the conflict and provide commands to the hyperloop pods such that the conflict is resolved, thus allowing the pods to traverse the junction (or branch).

The depot queue routing module 451 is generally configured to direct pods to appropriate queues in order to facilitate convoy formations. A convoy may be physical or logical, as stated herein. Likewise, pods may be queued at a depot such that the pods may depart as part of a convoy. One of skill in the art will appreciate that a convoy may be necessary to address a particular need of the hyperloop network 104. For example, in FIG. 1D, a fire may be burning near the suburbs 109A, 109B, 109C. If the inhabitants cannot safely travel along the roads 111A, 111B, 111C, 111D, 111J, more hyperloop pods may be queued at the portal 115B and sent to the portal 115A such that more pods arrive at the portal 115A in order to rescue fleeing inhabitants.

The maintenance bay scheduling module 453 is generally configured to manage allocation of available maintenance bays. In one aspect, the maintenance bay scheduling module 453 determines the number of available and unavailable maintenance bays within a depot. Hyperloop pods, like other vehicles, require periodic maintenance and inspection. However, to adequately perform said maintenance and inspection, the pod may need to be docked at a special bay that is configured to manipulate the pod in order for crews and machines to carry out actions (to address an issue).

The depot convoy formation module 455 is generally configured to coordinate with the depot queue routing module 451 to cause the pods to depart and arrive according to a defined queue. Given the myriad of conditions and risks present in a depot, as well as the hyperloop network 104 as a whole, convoy formations may be quite dynamic. As such, the depot convoy formation module 455 physically arranges the pods, via commands, according to a defined queue that provides safe and reliable departure and arrival of pods.

FIG. 4E is a block diagram of the EAP operation system 417. The EAP operation system 417 comprises an EAP zone controller 457, an EAP situational awareness module 459, and an EAP management module 461.

The EAP zone controller 457 is generally configured to manage communication and control commands shared between the hyperloop pod system 213 and the wayside support system 211. In one aspect, the EAP zone controller 457 communicates with the EAP situational awareness module 459 to determine the current risks and conditions affecting the hyperloop pod system 213 that is reporting an emergency issue. In another aspect, EAP zone controller 457 communicates with the EAP management module 461 to direct the hyperloop pod system 213 by use of commands sent to the hyperloop pod system 213 (e.g., increase velocity, halt, unload passengers, etc.).

The EAP situational awareness module 459 is configured to detect risks and conditions of the operating state. The hyperloop network 104 may experience an emergency that introduces risks that need to be addressed to ensure the safe and reliable operation of the pods operating in the hyperloop network 104. For example, in FIG. 1D, if a pod is halted on the route 113A, the EAP situational awareness module 459 detects the halted pod and updates the operating state to indicate that the route 113A is no longer to be used until the emergency situation has been resolved (e.g., by sending emergency crews and rescuing passengers).

The EAP management module 461 is generally configured to direct the movements of pods that require access to an emergency access point. For example, a pod may be halted in a tube due to loss of power at the pod. The EAP management module 461 communicates with the EAP situational awareness module 459 in order to first detect the emergency situation and then to cause the traffic to navigate such that the emergency may be addressed. Further, the EAP management module 461 utilizes commands sent to the hyperloop pod system 213 that cause the pod experiencing an emergency to move to a safer position (e.g., one near an emergency access point where crews may provide assistance).

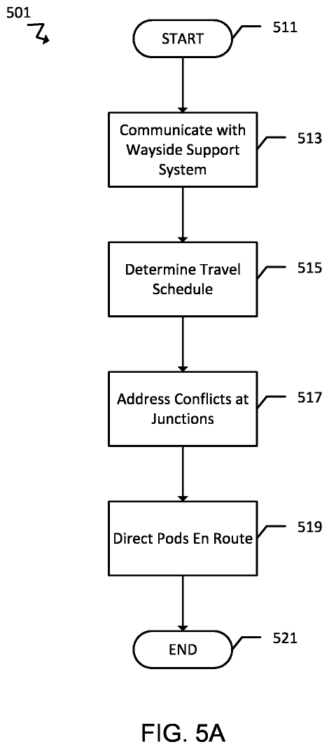

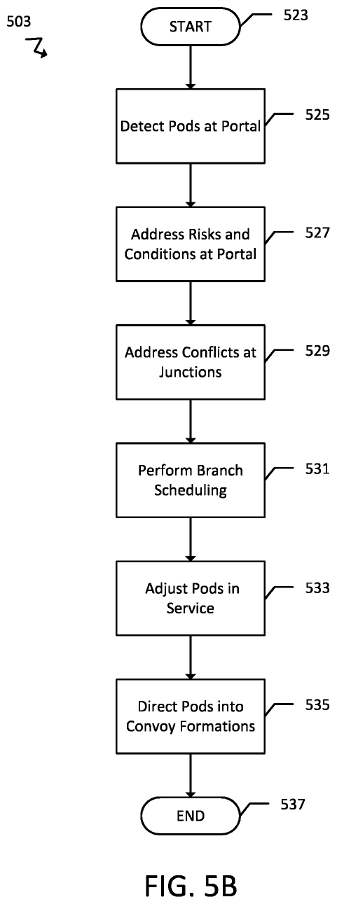

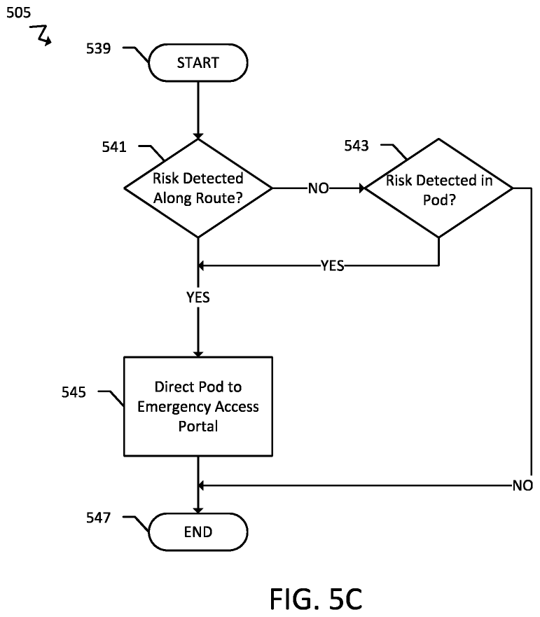

FIG. 5A is a flowchart illustrating a process 501 for directing a hyperloop pod that is operating en route in the hyperloop network 104. A hyperloop pod is considered en route when traveling along a route (e.g., the plurality of routes 113N). For example, in FIG. 1B, a hyperloop pod traveling from the portal 115C, along the route 113C, to the portal 115D is said to be en route. When the hyperloop pod is at or near a depot, the depot operation system 415 is generally responsible for directing the hyperloop pod. Likewise, when the hyperloop pod is at or near a portal, the portal operation system 413 is generally responsible for directing the hyperloop pod.

The process 501 begins at the start block 511 and proceeds to the block 513. At the block 513, the process 501 communicates with the wayside support system 414. The process 501 utilizes the autonomous traffic management system 409 and the transit operation system 411 to perform communication with the wayside support system 211. In one aspect, the wayside support system 211 comprises sensors and transponders located at or near a route. In one aspect, the wayside support system 211 also enables communication within portals, depots, junctions (branches), routes, or a combination thereof.

As the hyperloop pods traverse the hyperloop network 104, the travel-related information is communicated between the autonomous traffic system 409 and the hyperloop pod system 213. Travel-related information may include position, velocity, acceleration, gross weight, number of passengers, operational status, battery charge level, origin location, destination location, gross weight, operational range, etc. The process 501 utilizes the en route situational awareness module 421 to determine the travel-related information sent and received by the wayside support system 211. The process 501 then proceeds to the block 515.

At the block 515, the process 501 determines travel schedules. The process 501 utilizes the departure management module 423 within the transit operation system 411 to manage the travel scheduling. For example, the process 501 may set a departure time for a hyperloop pod using the departure management module 423. In one aspect, the management of the travel scheduling is informed by a policy generated by a human operator (as described herein). In one aspect, the process 501 communicates travel scheduling information to the hyperloop pod system 213 via the wayside support system 211. The process 501 then proceeds to the block 517.

At the block 517, the process 501 addresses conflicts at junctions (or branches). Various junctions (or branches) exist throughout any given hyperloop network. In one aspect, the junctions (or branches) may be within a portal or a depot (e.g., the plurality of portals 115N). As a hyperloop pod system 213 manages a hyperloop pod, a junction (or branch) may be encountered in which a conflict has been detected. For example, if two or more hyperloop pods are scheduled to pass through the same junction at a substantially same time, the process 501 invokes the functionality within the junction management module 425 to address the conflict such that the hyperloop pods pass safely through the junction (or branch). In one aspect, a convoy may be formed by the process 501 in order to enable conflict resolution and safe travel through the junction (or branch). The process 501 then proceeds to the block 519.

At the block 519, the process 501 directs pods en route. The process 501 communicates with the traffic operation system 411 in order to send commands via the wayside support system 211 such that the hyperloop pod system 213 utilizes substantially autonomous operations to carry out the command. One of skill in the art will appreciate that the hyperloop pod system 213 comprises systems of which some are autonomous and others are more conventional (e.g., substantially human-controlled). The supervisory traffic management system 209 provides one such interface for human-based control of the hyperloop network 104 and the autonomous traffic management system 409 (and related elements). The process 501 then proceeds to the end block 521 and terminates.

FIG. 5B is a flowchart illustrating a process 503 for directing a hyperloop pod at a portal within the hyperloop network 104. The process 503 begins at the start block 523 and proceeds to the block 525. At the block 525, the process 503 detects pods at a portal. For instance, in FIG. 1C a hyperloop pod may be traveling along the route 113G toward the portal 115G near the port 119A. As the hyperloop pod travels along the route 113G, the hyperloop pod system 213 is managed by the transit operation system 411 or the process 501. Once the hyperloop pod approaches the portal, the process 503 may detect the hyperloop pod arriving as reported by the wayside support system 211. In one aspect, the process 503 may utilize the portal situational awareness module 429 in order to detect the arrival and/or departure of a hyperloop pod.

In one aspect, the detection of hyperloop pods may utilize a number of sensors placed near or within the portal. For example, a plurality of Hall sensors may be located within a portal to track the movements of the hyperloop pods. In another aspect, wireless communication may be utilized to determine location of hyperloop network elements. In still another aspect, global positioning satellite technology may be utilized by the process 503. The process 503 then proceeds to the block 527.

At the block 527, the process 503 addresses risks and conditions at a portal. An example of a risk may be an obstruction near a docking bay. For example, a cargo tractor may inadvertently drop a cargo container. In one aspect, the process 503 utilizes the portal situational awareness module 529 to detect such risks and conditions affecting the operations within a portal.

A risk within the portal may be addressed by a number of mechanisms. For example, the process 503 may invoke functionality within the portal stable management module 437 to launch an additional pod into service upon detecting a pod is trapped at a loading bay (e.g., due to equipment failure). In another aspect, the process 503 may direct pods away from a risk by commanding the hyperloop pod system 213 within the affected pods. The process 503 then proceeds to the block 529.

At the block 529, the process 503 addresses conflicts at junctions (or branches). A portal may have any number of branches and subbranches that are interspersed throughout the portal. Further, hyperloop pods may encounter conflicts when attempting to navigate through a junction (or branch). As such, the process 503 may utilize the functionality within the portal situational awareness module 429 to address the conflicts occurring at the junctions (or branches). In one aspect, the process 503 invokes functionality within the portal junction management module 433 such that the pods are directed toward desired paths, which are not subject to conflicts with other hyperloop pods. The process 503 then proceeds to the block 531.

At the block 531, the process 503 performs branch scheduling. As stated, a portal may have a number of branches and subbranches. As such, the hyperloop pods not only require conflict-free navigation of the junctions (or branches) but also control along said branches and subbranches. For example, two docking bays may share a common branch that provides ingress to and egress from a portal. When two pods depart from each respective docking bay, the process 503 schedules one pod to depart prior to the other departing pod such that the branch can accommodate both departures without conflict, thus avoiding collision.

In one aspect, the process 503 utilizes functionality within the branch scheduling module 439. For example, the process 503 may determine the location of a pod by using the portal situational awareness module 429. Next, the process 503 performs branch scheduling via the branch scheduling module 439. Then, the process 503 sends commands to the hyperloop pod system 213 within the pod such that the pod may navigate the branches within the portal. The process 503 then proceeds to the block 533.

At the block 533, the process 503 adjusts the number of hyperloop pods in service. The hyperloop network 104 may have any number of pods operating therein. However, the number of hyperloop pods is unlikely to be static given the unpredictable nature of transportation. For example, in FIG. 1D, a rush hour commute between the suburb 109A and the city 107A may create higher demand during mornings and evenings. As such, the process 503 removes pods from or add pods to the hyperloop network 104 in order to meet demand.

In one aspect, the process 503 utilizes the portal stable management module 437. In another aspect, the portal stable management module 437 may communicate with the depot operation system 415 in order to access pods stored within a depot. In still another aspect, the portal stable management module 437 may access pods stored at a different portal having the requisite number of pods desired by the process 503. The process 503 then proceeds to the block 535. At the block 535, the process 503 directs one or more hyperloop pods into a convoy. A convoy may be a series of hyperloop pods arranged logically or physically along a segment of the hyperloop track. Forming a convoy of pods provides more efficient and safer operation of the hyperloop network 104 because the convoy may be treated one unit when performing conflict resolution between two pods (or convoys) requiring access to the same branch, route, junction, etc. The process 503 then proceeds to the end block 537 and terminates.

FIG. 5C is a flowchart illustrating a process 505 for directing a hyperloop pod to an emergency access point. The process 505 begins at the start block 539 and proceeds to the decision block 541. At the decision block 541, the process 505 determines whether a risk exists along the route. In one aspect, the process 505 utilizes the EAP situational awareness module 459. An example of a risk may be a halted pod that cannot move without emergency assistance. If a risk is not detected, the process 505 proceeds along the NO branch to the decision block 543. Returning to the decision block 541, if a risk is detected along the route, the process 505 proceeds along the YES branch to the block 545.

At the block 545, the process 505 directs a pod to an EAP. Given the near-vacuum environment within a hyperloop tube, providing commands to the hyperloop pod system 213 in order to direct a pod to safety is highly desirable. For example, a pod may not have enough energy remaining to traverse the route using full power. However, the process 505 may direct the hyperloop pod system 213 to an EAP by invoking low-power, low-velocity propulsion systems within the pod.

In another aspect, the process 505 directs other pods such that another pod may reach the EAP without interference. For example, hyperloop pods directed to travel along a route having a distressed pod may be routed away from the distressed pod, and the process 505 may invoke the functionality within the transit operation system 411 to do so. The process 505 then proceeds to the end block 547 and terminates.

Returning to the decision block 543, if a risk has been detected within the pod, the process 505 proceeds along the YES branch to the block 545. An example of a risk within a pod is a pod having insufficient power to reach a portal. As such, the hyperloop pod system 213 may report the issue such that the process 505 invokes functionality within the EAP management module 461 in order to direct the pod to an EAP. Returning to the decision block 543, if a risk has not been detected in the hyperloop pod, the process 505 proceeds along the NO branch to the end block 547 and terminates.

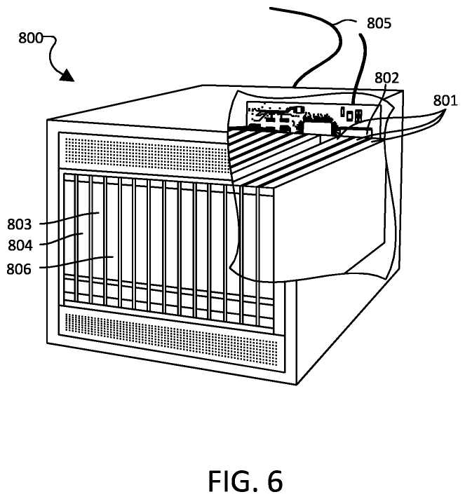

FIG. 6 is a block diagram illustrating a server 800 suitable for use with the various aspects described herein. In one aspect, the server 800 is configured to execute the supervisory traffic management system 209 and the autonomous traffic management system 409 as well as execute the processes 301, 303, 305, 307, 309, 501, 503, 505.

The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, etc.). As illustrated in instant figure, processor assemblies 801 may be added to the server 800 by insertion into the racks of the assembly. The server 800 may also include an optical drive 806 coupled to the processor 801. The server 800 may also include a network access interface 803 (e.g., an ethernet card, WIFI card, etc.) coupled to the processor assemblies 801 for establishing network interface connections with a network 805. The network 805 may be a local area network, the Internet, the public switched telephone network, and/or a cellular data network (e.g., LTE, 5G, etc.).

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage configured to store instructions or code. Disc refers to any optical disc configured to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A method for supervised management of an autonomous hyperloop network, the method comprising:
detecting a first input, at a user interface, to select, at a processor, a first play within a plurality of plays, the first play containing a first operation, the first operation causing a first hyperloop pod to invoke a first autonomous operation;
executing, at the processor, the first play;
detecting a second input, at the user interface, to select, at the processor, a second play within the plurality of plays, the second play containing a second operation, the second operation causing a second hyperloop pod to invoke a second autonomous operation;
executing, at the processor, the second play; and
monitoring, at the processor, a wayside support system.

2. The method of claim 1, the method further comprising:
detecting a third input, at the user interface, to define, at the processor, a set of operational parameters;
detecting a fourth input, at the user interface, to define, at the processor, a set of global restrictions;
detecting a fifth input, at the user interface, to define, at the processor, a policy, the policy relating to the set of operational parameters, the set of global restrictions, or a combination thereof, the policy further limiting the first operation, the second operation, or a combination thereof;
detecting a sixth input, at the user interface, to select, at the processor, the policy; and
executing, at the processor, the policy, the executing causing the first play and the second play to conform to the policy.

3. The method of claim 1, the method further comprising:
detecting, at the processor, an issue reported by the wayside support system; and
sending, via the wayside support system, a third autonomous operation to the first hyperloop pod.

4. The method of claim 3, wherein the issue is traffic-related, maintenance-related, safety-related, or a combination thereof.

5. The method of claim 3, the method further comprising:
generating, at the processor, an assessment report containing a first action, the first action being configured to address an issue in the hyperloop network;
presenting, at the user interface, the assessment report; and
presenting, at the user interface, the first action.

6. The method of claim 5, the method further comprising:
generating, at the processor, a recommendation to execute the first action, the recommendation being derived from the issue;
presenting, at the user interface, the recommendation;
detecting an eighth input, at the user interface, to execute the recommendation; and
executing, at the processor, the recommendation.

7. The method of claim 1, the method further comprising:
detecting, at the processor, a conflict at a junction within the hyperloop network, the conflict occurring if the second hyperloop pod is scheduled to traverse the junction at substantially the same time as the first hyperloop pod; and
commanding, via the wayside support system, the first hyperloop pod to traverse the junction before the second hyperloop pod is scheduled to traverse the junction.

8. The method of claim 7, the method further comprising:
determining, at the processor, the junction as being a branch within a hyperloop portal;
adjusting, at the processor, the number of hyperloop pods operating within the hyperloop network; and
directing, via the wayside support system, the first hyperloop pod into a convoy comprised of one or more hyperloop pods, the second hyperloop pod being among the one or more hyperloop pods.

9. The method of claim 1, the method further comprising:
detecting, at the processor, an emergency within a first hyperloop route, the first hyperloop route being part of the hyperloop network; and
directing, via the wayside support system, the first hyperloop pod to an emergency access point; and
directing, via the wayside support system, the second hyperloop pod to avoid the emergency via a second hyperloop route, the second hyperloop route being part of the hyperloop network.

10. A computing device configured to supervise the operation of an autonomous hyperloop network, the computing device comprising:
a user interface;
a memory;
a processor, the processor configured to:
detect a first input, at the user interface, to select a first play within a plurality of plays, the first play containing a first operation, the first operation causing a first hyperloop pod to invoke a first autonomous operation;
execute the first play;
detect a second input, at the user interface, to select a second play within the plurality of plays, the second play containing a second operation, the second operation causing a second hyperloop pod to invoke a second autonomous operation;
execute the second play; and
monitor a wayside support system.

11. The computing device of claim 10, the processor being further configured to:
detect a third input, at the user interface, to define a set of operational parameters;
detect a fourth input, at the user interface, to define a set of global restrictions;
detect a fifth input, at the user interface, to define a policy, the policy relating to the set of operational parameters, the set of global restrictions, or a combination thereof, the policy further limiting the first operation, the second operation, or a combination thereof, the policy further being stored in the memory;
detect a sixth input, at the user interface, to select the policy from the memory; and
execute the policy, the executing causing the first play and the second play to conform to the policy.

12. The computing device of claim 10, the processor being further configured to:
detect an issue reported by the wayside support system; and
send, via the wayside support system, a third autonomous operation to the first hyperloop pod.

13. The computing device of claim 12, wherein the issue is traffic-related, maintenance-related, safety-related, or a combination thereof.

14. The computing device of claim 13, the processor being further configured to:
generate an assessment report containing a first action, the first action being configured to address an issue in the hyperloop network, the assessment report being stored in the memory;
present, at the user interface, the assessment report; and
present, at the user interface, the first action.

15. The computing device of claim 14, the processor being further configured to:
generate a recommendation to execute the first action, the recommendation being derived from the issue;
present, at the user interface, the recommendation;
detect an eighth input, at the user interface, to execute the recommendation; and
execute the recommendation.

16. The computing device of claim 10, the processor being further configured to:
detect a conflict at a junction within the hyperloop network, the conflict occurring if the second hyperloop pod is scheduled to traverse the junction at substantially the same time as the first hyperloop pod; and
command, via the wayside support system, the first hyperloop pod to traverse the junction before the second hyperloop pod is scheduled to traverse the junction.

17. The computing device of claim 16, the processor being further configured to:
determine the junction as being a branch within a hyperloop portal;
adjust the number of hyperloop pods operating within the hyperloop network; and
direct, via the wayside support system, the first hyperloop pod into a convoy comprised of one or more hyperloop pods, the second hyperloop pod being among the one or more hyperloop pods.

18. The computing device of claim 10, the processor being further configured to:
detect an emergency within a first hyperloop route, the first hyperloop route being part of the hyperloop network; and
direct, via the wayside support system, the first hyperloop pod to an emergency access point; and
direct, via the wayside support system, the second hyperloop pod to avoid the emergency via a second hyperloop route, the second hyperloop route being part of the hyperloop network.

19. A computer-readable medium storing instructions that, when executed by a computer, cause the computer to:
detect a first input, at a user interface, to select a first play within a plurality of plays stored in a memory, the first play containing a first operation, the first operation causing a first hyperloop pod to invoke a first autonomous operation;
execute, at a processor, the first play;
detect a second input, at the user interface, to select a second play within the plurality of plays, the second play containing a second operation, the second operation causing a second hyperloop pod to invoke a second autonomous operation;
execute, at a processor, the second play; and
monitor, at the processor, a wayside support system.

20. The computer-readable medium of claim 19, the instructions further causing the computer to:
detect a third input, at the user interface, to define a set of operational parameters;
detect a fourth input, at the user interface, to define, at the processor, a set of global restrictions;
detect a fifth input, at the user interface, to define, at the processor, a policy, the policy relating to the set of operational parameters, the set of global restrictions, or a combination thereof, the policy further limiting the first operation, the second operation, or a combination thereof, the policy further being stored in the memory;
detect a sixth input, at the user interface, to select, at the processor, the policy from the memory; and
execute, at the processor, the policy, the executing causing the first play and the second play to conform to the policy.
